(19) United States
(12) Patent Application Publication
(10) Pub. No.: US 2025/0206280 A1
(43) Pub. Date: Jun. 26, 2025

(54) ELECTROMECHANICALLY-HYDRAULICALLY OPERABLE WHEEL BRAKE

(71) Applicant: Continental Automotive Technologies GmbH, Hannover (DE)

(72) Inventors: Peter Stauder, Mainz (DE); Kristijan Tarandek, Neu-Isenburg (DE); Dirk Pauly, Frankfurt am Main (DE); Jürgen Böhm, Oberneisen (DE)

(73) Assignee: Continental Automotive Technologies GmbH, Hannover (DE)

(21) Appl. No.: 18/980,783

(22) Filed: Dec. 13, 2024

(30) Foreign Application Priority Data
Dec. 20, 2023 (DE) 10 2023 213 111.0

(51) Int. Cl. B60T 13/58; B60T 1/06; B60T 8/17; B60T 13/12; B60T 13/74; B60T 17/22; F16D 55/226; F16D 65/18; F16D 65/38; F16D 65/40; F16D 66/00; F16D 121/04; F16D 121/24; F16D 127/02

(52) U.S. Cl. CPC B60T 13/588; B60T 1/065; B60T 8/17; B60T 13/12; B60T 13/746; B60T 17/22; F16D 55/226; F16D 65/18; F16D 65/40; B60T 2270/402; B60T 2270/413; F16D 2065/386; F16D 2066/005; F16D 2121/04; F16D 2121/24; F16D 2127/02

(57) ABSTRACT

A wheel brake for a motor vehicle which can be operated electromechanically and/or hydraulically. The wheel brake includes a brake caliper module having at least one electromechanically operable braking device and having at least one hydraulically operable braking device.

### CROSS-REFERENCE TO RELATED APPLICATIONS

The present application claims priority to German patent application No. 10 2023 213 111.0, filed on Dec. 20, 2023, which is hereby incorporated by reference.

### TECHNICAL FIELD

The technical field relates in general to a wheel brake for a motor vehicle which can be operated electromechanically and/or hydraulically.

### BACKGROUND

Known examples of wheel brakes include fixed calipers with hydraulic pistons on the inner and outer sides, and floating caliper brakes with a hydraulic brake piston on the inner side of the wheel. Also known, in addition, are combined wheel brakes, referred to as combination calipers, which combine a hydraulic piston with a mechanical adjustment device for parking or as a parking brake or for emergency actuation.

Wheel brakes that can be actuated by purely electrical means, also referred to as electromechanical wheel brakes (“EMB”), are also increasingly being employed as brake systems for motor vehicles. These wheel brakes offer a number of advantages over conventional, purely hydraulically actuable, wheel brakes. Thus, there is no longer a need for a complex hydraulic system, and an electromechanical wheel brake also takes up significantly less space. Electromechanical wheel brakes of this kind typically have an electric or electronic drive unit, which interacts with a mechanism or transmission. A braking unit can then be arranged on the output side, and this can comprise a brake piston with a friction lining, which can be pressed against a brake disk or, alternatively, a drum by means of a translational movement. It is thereby possible to bring about deceleration during the operation of the wheel brake. An electromechanical wheel brake is described in DE 10 2017 206 798 A1, for example.

Here, the electric drive unit can comprise an electrically driven motor, also referred to subsequently as an actuator. In this case, the associated functions for operating or controlling the actuators are typically stored in an electronic control device or brake control unit.

Here, it is possible, for example, to provide a force controller which, on the basis of a specified setpoint force, which can correspond to a driver braking requirement or can be made available by a higher-level on-board computer, can generate a setpoint value for the actuator speed or rotation rate in order to apply a brake application force to an associated wheel brake. In the case of electromechanical wheel brakes, sensors, in particular force sensors, are often provided to measure the applied clamping force since direct hydraulic braking by a vehicle driver is no longer possible. Force sensors of this kind are relatively expensive and complex in terms of arrangement in or on the wheel brake.

Electromechanical wheel brakes can be designed as service brakes. In this case, the function of the parking brake can then be implemented by locking the transmission. In the case of purely hydraulically actuable wheel brakes, it is not possible to implement a parking brake, and therefore additional components are required in this case.

Accordingly, a wheel brake which combines the advantageous properties of the hydraulic or electromechanically actuable wheel brakes outlined above and mitigates or ideally completely obviates the associated disadvantages is desirable.

### SUMMARY

This disclosure provides a wheel brake, in particular for a motor vehicle, and a motor vehicle having a wheel brake of this kind.

In a first aspect, the disclosure relates to a wheel brake, in particular for a motor vehicle, including:
a brake caliper module having a brake caliper housing,
at least one hydraulic braking device having a hydraulic braking part,
at least one electromechanical braking device having an electromechanical braking part,
a friction partner, preferably a brake disk, which is arranged between the hydraulic braking part and the electromechanical braking part,
wherein
   the hydraulic braking device can act on the hydraulic braking part and move the latter axially, thereby enabling a first axial force F_{H} to be applied during operation,
   the electromechanical braking device can act on the electromechanical braking part and move the latter axially, thereby enabling a second axial force F_{E} to be applied during operation,
   and wherein the first axial force F_{H} and the second axial force F_{E} of the wheel brake are opposed, in particular directed toward one another.

For the purposes of the disclosure, a motor vehicle refers to a vehicle that has axles, wherein at least one of these axles can comprise steerably guided wheels and, furthermore, the driving of the wheels on at least one axle can be adapted in a wheel-specific manner.

The disclosure proposes a combination of at least one hydraulic braking device and at least one electromechanical braking device, the intention being, in particular, to bring out the strengths of the respective braking device. It is highly advantageous to arrange both the hydraulic braking device and the electromechanical braking device in a brake module, in particular on or in an associated housing. The brake module can be a brake caliper module, for example, and the housing can accordingly be an associated brake caliper housing.

The disclosed wheel brake thus allows a clear separation of functions and of the associated components or subassemblies, and this can offer advantages in terms of design and cost.

The disclosure is suitable in principle for a very wide variety of wheel brake types; purely by way of example, mention may be made at this point of disk or caliper brakes, in particular floating caliper brakes.

Here, the hydraulic braking device can be designed in a manner that is substantially analogous to existing or known hydraulic wheel brakes, wherein a hydraulic pressure is generated in a fluid system and, during operation, this can bring about a movement or axial displacement of a braking part, in particular a brake piston, in order to generate a brake application force. For greater clarity, this braking part is also referred to below as a hydraulic braking part. For this purpose, the hydraulic braking part can be connected to a friction element, which can be pressed against a friction partner, e.g. a brake disk, in order to generate a deceleration torque at the associated vehicle wheel.

The electromechanical braking device can be designed in such a way that a translational movement of a braking part and/or a brake application force can be generated by means of a drive unit and a transmission unit. The braking part, also referred to below for greater clarity as an electromechanical braking part, can be connected to a friction element. In this case, the electromechanical braking part can be pressed against a friction partner, e.g. a brake disk.

In a particularly space-saving way, the friction partner can be arranged between the at least one hydraulic braking part and the at least one electromechanical braking part. The friction partner can comprise a brake disk, for example.

In this context, the brake application force refers to the force with which the friction elements are pressed against the friction partner or brake disk. In operation, a corresponding braking torque is thereby generated at the wheel under consideration. Depending on the embodiment and control concept, the control system may be selected in such a way that either a predetermined, defined clamping force or a predetermined, defined braking torque is set in accordance with the deceleration demand requested.

During operation, the hydraulic braking device can accordingly act on the hydraulic braking part and move the latter axially, thereby enabling a first axial force F_{H} to be applied, and the electromechanical braking device can act on the electromechanical braking part and move the latter axially, thereby enabling a second axial force F_{E} to be applied. Both braking devices may be controlled individually or separately from one another.

In an extremely advantageous manner, the hydraulic braking part and the electromechanical braking part are in this case arranged in such a way that the first axial force F_{H} and the second axial force F_{E} are opposed, in particular directed toward one another, during the operation of the wheel brake. In this way, the friction partner situated between the two braking parts can be subjected to the corresponding axial forces F_{H} and F_{E} from two opposite sides.

According to one embodiment, the hydraulic braking device may be designed as a service brake. Thus, the hydraulic braking device can be responsible for the normal braking function and designed accordingly. This makes it possible to exploit the advantages of a hydraulic braking device. Thus, for example, the force measurement can be performed in a particularly simple manner by means of a pressure sensor, which is generally significantly simpler and less expensive than, for example, a force sensor of the kind that is often necessary with electromechanical brakes.

The disclosed wheel brake makes it possible in an extremely advantageous manner to use the electromechanical braking device of the wheel brake in a supplementary or supportive role in order to implement additional functions. These functions can comprise readjustment for wear, setting of the release clearance, the parking brake function, redundant emergency actuation, and/or increasing braking dynamics.

This separation of functions makes it possible to exploit the advantages of an electromechanical braking device without having to accept the disadvantages that result from the use of an electromechanical braking device as a service brake. Thus, for example, the arrangement of the braking devices can be configured in a very space-saving way and this can be very advantageous from the point of view of the restricted space conditions in or on a vehicle wheel. Moreover, it is also possible to apply particularly high axial or brake application forces since the axial forces can act in opposite directions to one another.

The readjustment for wear can be associated with setting of the release clearance and can be employed, for example, when the friction elements or friction partners exhibit wear or abrasion of the material due to operation and, as a result, the release clearance between the friction elements increases. However, the release clearance can also be set independently of the wear. Readjustment for wear and setting of the release clearance can be accomplished by moving the electromechanical braking parts into a corresponding axial position at the beginning of a trip. Readjustment during the trip is also possible.

A parking brake function can be implemented in a particularly advantageous way by means of an electromechanical braking device since, for example, the associated transmission can be locked. This can be done, for example, by driving in a locking plunger. It is thereby possible in an extremely advantageous way to achieve retention on the basis of self-locking even in a de-energized state.

Embodiments in which the transmission comprises a worm gear mechanism are also possible. This is already self-locking and in this way can provide a parking brake function. Moreover, embodiments in which the transmission has a high efficiency and a parking brake function can then be implemented by means of a locking plunger are possible.

The parking brake function can be implemented, for example, if the at least one hydraulic braking part is retracted and only the at least one electromechanical braking part provides the clamping or clamping force by axial movement in the brake application direction. In this case, the friction partner can, for example, be pressed against the at least one retracted electromechanical braking part or, if this braking part has moved back into the housing, alternatively against surrounding housing regions. For this purpose, these housing regions, e.g. corresponding regions in the interior of a brake caliper housing, can be appropriately equipped or designed, e.g. with slightly projecting pressure points.

The electromechanical braking device can also perform emergency actuation if there is a failure of the hydraulic braking device since they act independently of the hydraulic braking system and can in this way provide redundancy.

Moreover, by situation-dependent setting of the release clearance as described further above, it is also possible to achieve an increase in the braking dynamics.

The disclosed wheel brake accordingly combines the advantageous properties of the two types of braking devices in an extremely advantageous way while avoiding the disadvantageous properties of each.

The mutually opposed axial forces F_{H} and F_{E} make it possible to apply particularly high forces, and therefore the disclosed wheel brake is also suitable for applying high brake application forces.

This can be further assisted by an arrangement in which the axes of action of at least one electromechanical and at least one hydraulic braking part are at least collinear, preferably coaxial, with respect to one another. In other words, it is possible through the arrangement and alignment of the hydraulic braking part to define a first hydraulic axis of action, which can correspond to the axis of symmetry of the hydraulic braking part, and through the electromechanical braking part to define a second electromechanical axis of action, which can correspond to the axis of symmetry of the electromechanical braking part. According to one embodiment, these two axes of action can be aligned collinearly, particularly preferably coaxially, with respect to one another. Accordingly, the axes of action correspond to the direction of the axial forces F_{H} and F_{E}.

Accordingly, the friction partner arranged between them can be subjected to the brake application force from opposite or opposed directions.

It may be particularly advantageous if at least one hydraulic axis of action and one electromechanical axis of action are coaxial with respect to one another, thus enabling the interposed friction partner to be subjected to the pressure force from opposite directions at the same position. In this way, it is possible to counteract tilting or tipping or other unwanted deformations of the friction partners due, for example, to excessive brake application forces. It is thus possible to further increase the brake application forces that can be applied.

Of course, other embodiments and arrangements with a different number and/or size of hydraulic braking parts and/or electromechanical braking parts are also possible. For example, two, three or four hydraulic braking parts can be provided with just one electromechanical braking part, or it is also possible, for example, to provide two electromechanical braking parts. In these cases, it is not always possible to arrange the corresponding axes of action collinearly or even coaxially with respect to one another, but this is possible according to the invention.

According to one embodiment, the hydraulic braking device may be arranged on the outward-facing side of the wheel brake, that facing away from the motor vehicle, this corresponding to conventional concepts and thus entailing a low outlay on adaptation. Accordingly, at least the hydraulic braking part may be arranged on the outward-facing side of the friction partner or brake disk.

If the electromechanical braking device is used for the function of readjustment for wear and/or setting of the release clearance, the hydraulic braking part can be of very compact design, especially in respect of the axial adjustment travel, since the stroke can be very limited. In this way, the hydraulic braking part can be of very slim design and can come very close to the rim, thus enabling the arrangement to be of very space-saving design.

Accordingly, the electromechanical braking device can be arranged on the opposite side of the wheel brake, that facing the vehicle, and this may be advantageous in respect of the arrangement of the drive unit. Accordingly, the electromechanical braking part and/or the associated drive unit and/or the associated transmission unit can be arranged on the vehicle-facing side of the friction partner or brake disk.

According to a particularly advantageous embodiment, the hydraulic braking device may be designed as a closed hydraulic system within the wheel brake. This means that the wheel brake can include the components and functions required for the operation of the hydraulic braking device, in particular without the need for a supply from a higher-level system. In other words, there is no need for a connection to a higher-level hydraulic system, and this makes the arrangement and assembly of the wheel brake according to the invention simpler and less expensive.

Moreover, the expenditure on maintenance work can be reduced. It may even be possible to achieve freedom from maintenance if the required fluid reservoir for the hydraulic brake fluid is provided as a self-contained system for each wheel. This has the great advantage that there is no longer a need for a separate larger fluid tank since lining wear can be compensated by means of the electromechanical braking device. As a result, the hydraulic braking device can be of compact and space-saving design. Accordingly, the hydraulic system can be of low-maintenance or even maintenance-free design if the hydraulic system is configured for the expected life of the wheel brake.

In a known manner, the hydraulic braking device can comprise a driving device, e.g. a motor gear unit (MGU), which can preferably likewise be arranged on or within the wheel brake and can be operatively connected to the fluid reservoir in order to move the hydraulic braking part.

For this purpose, the hydraulic braking device can have a transmitter element, e.g., a hydraulic pump. It is likewise advantageous to arrange this on or within the wheel brake.

According to a development of the disclosure, provision can be made to sense leakage of the hydraulic system. This can be accomplished in a particularly simple manner by advancing the electromechanical braking device out of a defined position to check whether the feed travel remains the same or must be increased since, for example, the hydraulic braking part is no longer being moved far enough axially in the direction of the electromechanical braking part.

According to one embodiment, the hydraulic braking device may have an electronic control unit (“ECU”), which is designed to control the hydraulic braking device and to perform pressure control. This ECU can likewise be arranged on or in the wheel brake.

Thus, only a single interface with the vehicle is now required, ensuring signal transmission, e.g., to a higher-level on-board or vehicle computer, and the supply of electric power. Complex assembly of the wheel brake with connection and linking of hydraulic systems is thus eliminated in an extremely advantageous manner. The vehicle manufacturer may also dispense with a hydraulic braking system if control is exercised via the signal line, which, in particular, also supports interaction with electronic brake pedals (ePedal).

Similarly, the electromechanical braking device can also comprise a drive unit for generating a torque, which may be arranged on or within the wheel brake. Furthermore, the electromechanical braking device can comprise a transmission unit for transmitting the torque from the drive unit to the electromechanical braking part. The transmission unit can comprise a rotation-translation mechanism in order, on the basis of a drive torque, to bring about a translational movement of the electromechanical braking part. The transmission unit and/or the rotation-translation mechanism can be arranged on or within the wheel brake. According to a preferred embodiment of the invention, the rotation-translation mechanism can comprise a spindle drive.

According to one embodiment, the electromechanical braking device can also have an electronic control unit (“ECU”), which is designed to control the electromechanical braking device.

It is particularly advantageous to combine this control unit with that of the hydraulic braking device, ensuring that only one brake control unit is required, which can be arranged as a wheel control unit (“WCU”) on or in the wheel brake.

According to another development of the invention, the wheel brake may include more than one, preferably two, three, four, or more hydraulic braking devices and/or more than one, preferably two or more electromechanical braking devices. In this way, an even higher brake application force can be applied. Moreover, it is also possible in this way to achieve very high redundancy on account of the multiple presence of the braking devices. According to an embodiment of this development, the more than one, preferably two or more hydraulic braking devices and/or the more than one, preferably two or more electromechanical braking devices can be arranged parallel to one another, which saves space and also allows a compact construction of the wheel brake. An opposed arrangement in pairs has proven particularly advantageous.

While the fluid line can easily be routed to a plurality of hydraulic braking parts by means of branching, force transmission between two EMB braking parts for the electromechanical braking device can be accomplished by means of a transmission stage. This can comprise a spur gear transmission, for example.

In a further aspect, the disclosure also includes a motor vehicle comprising at least one wheel brake as described above.

### BRIEF DESCRIPTION OF THE DRAWINGS

Further details and advantages of the disclosure will become apparent from the description of the illustrated exemplary embodiments and the attached claims.

In the drawings:

FIG. 1 shows a schematic view of part of an illustrative wheel brake, and

FIG. 2 shows another schematic view of part of an illustrative wheel brake.

### DETAILED DESCRIPTION

In the following detailed description of embodiments, for the sake of clarity, the same reference signs designate substantially identical parts in or on these embodiments. However, for better clarification of the invention, the embodiments illustrated in the figures are not always drawn to scale.

For reasons of clarity, only those elements of the braking device 100 which are relevant for the embodiment of the disclosed approaches are illustrated here.

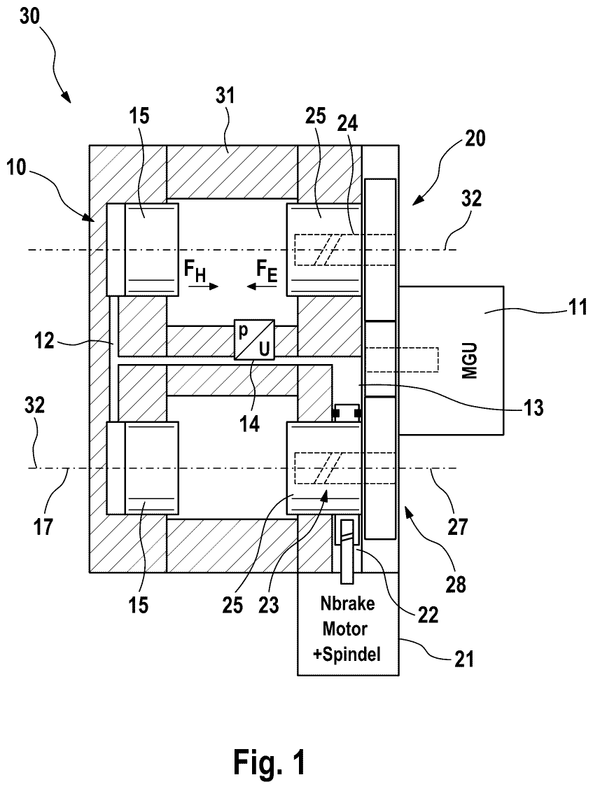

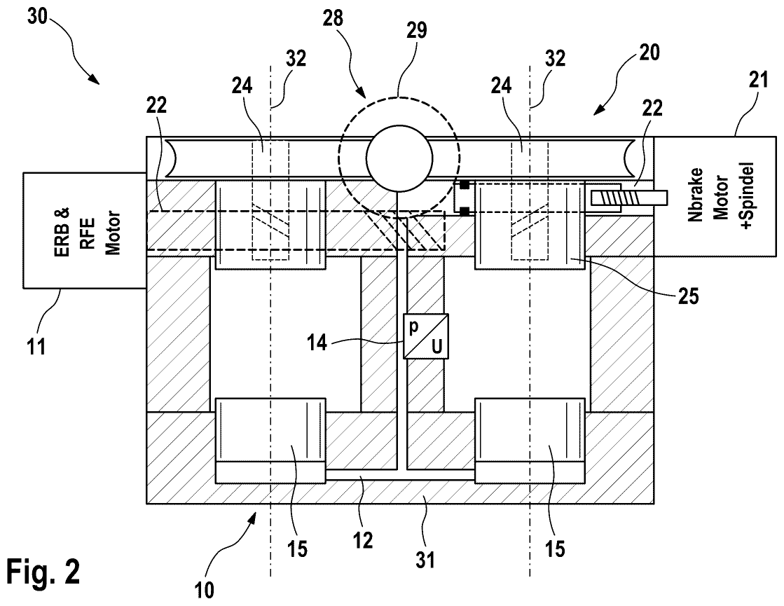

FIG. 1 shows a schematic view of part of an illustrative wheel brake 30 in a plan view, and FIG. 2 shows another schematic view of part of an illustrative wheel brake 30, likewise in a plan view. In particular, the wheel brake 30 can be used for the wheels of a motor vehicle.

The wheel brake 30 illustrated by way of example includes:
a brake caliper module 30 having a brake caliper housing 31,
at least one hydraulic braking device 10 having a hydraulic braking part 15,
at least one electromechanical braking device 20 having an electromechanical braking part 25,
a friction partner, such as a brake disk, which is arranged between the hydraulic braking part 15 and the electromechanical braking part 25,
wherein
   the hydraulic braking device 10 can act on the hydraulic braking part 15 and move the latter axially, thereby enabling a first axial force F_{H} to be applied during operation,
   the electromechanical braking device 20 can act on the electromechanical braking part 25 and move the latter axially, thereby enabling a second axial force F_{E} to be applied during operation,
   and wherein the first axial force F_{H} and the second axial force F_{E} of the wheel brake are opposed, in particular directed toward one another.

In the present case, the wheel brake 30 is designed as a floating caliper brake.

The hydraulic braking device 10 is designed to generate a hydraulic pressure in a fluid system, thereby enabling movement or axial displacement of the hydraulic braking part 25 to be brought about during operation. It is thereby possible to generate a brake application force. The hydraulic braking part 25 in the exemplary embodiment is designed as a brake piston. The hydraulic braking part 25 is connected to a friction element (not illustrated), which can be pressed against a friction partner, e.g. a brake disk (not illustrated), in order to generate a deceleration torque at the associated vehicle wheel.

The electromechanical braking device 20 is designed to bring about a translational movement of the electromechanical braking part 25 in order to generate a brake application force by means of a drive unit 21 and a transmission unit 22. In the exemplary embodiment, the electromechanical braking part 25 is designed as a piston and is connected to a friction element (not illustrated), which can be pressed against a friction partner (not illustrated).

The friction partner is arranged in a particularly space-saving manner between the hydraulic braking part 15 and the electromechanical braking part 25 and, in the exemplary embodiment shown, comprises a brake disk (not illustrated).

During the operation of the wheel brake 30, the hydraulic braking device 10 can act on the hydraulic braking part 15 and move the latter axially, thereby enabling a first axial force F_{H} to be applied, and the electromechanical braking device 20 can act on the electromechanical braking part 25 and move the latter axially, thereby enabling a second axial force F_{E} to be applied.

In the embodiments of the wheel brake 30 which are shown in FIGS. 1 and 2, two hydraulic braking parts 15 and two electromechanical braking parts 25 are depicted in each case. Of course, embodiments with more or fewer hydraulic or electromechanical braking parts 15, 25 are also possible, e.g. with two hydraulic braking parts 15 and one electromechanical braking part 25.

In the embodiments depicted, the braking parts 15, 25 are furthermore arranged in such a way that the first axial force F_{H} and the second axial force F_{E} are opposed, in particular directed toward one another, during the operation of the wheel brake. In this way, the friction partner situated between the two braking parts can be subjected to the corresponding axial forces F_{H} and F_{E} from two opposite sides.

In the embodiment shown, the hydraulic braking device 10 is designed as a service brake. Accordingly, the hydraulic braking device 10 is responsible for the normal braking function. The force measurement can be accomplished by means of a pressure sensor 14, which can measure the pressure in the fluid system in the hydraulic line 12.

In the embodiment shown, the electromechanical braking device 20 of the wheel brake 30 is furthermore used to achieve additional functions. These functions can comprise readjustment for wear, setting of the release clearance, the parking brake function, redundant emergency actuation, and/or increasing braking dynamics. As provided in the present case for the exemplary embodiment shown, it is also possible to perform all the functions within the electromechanical braking device 20.

The mutually opposed axial forces F_{H} and F_{E} make it possible to apply particularly high forces, and therefore the wheel brake described herein is also suitable for applying high brake application forces.

This can be further assisted by an arrangement in which the axes of action of at least one electromechanical and at least one hydraulic braking part are at least collinear, preferably coaxial, with respect to one another. In the embodiments shown in FIGS. 1 and 2, this is clearly apparent since in each case two electromechanical and hydraulic braking parts 15, 25 are provided, which are arranged opposite one another in pairs as it were.

The hydraulic axes of action 17 of the hydraulic braking part 15 and the electromechanical axes of action 27 of the electromechanical braking parts 25 are collinear, in particular coaxial, with respect to one another. It is thereby possible to define a common axis of action 32. Accordingly, the respective braking parts 15, 25 can introduce the axial forces F_{H} and F_{E} onto the friction partner or brake disk at the same location from opposite directions. In this way, it is possible to counteract tilting or tipping or other unwanted deformations of the friction partners due, for example, to excessive brake application forces. It is thus possible to further increase the brake application forces that can be applied. Embodiments with just one hydraulic braking part 15 and just one electromechanical braking part 25, in which the respective axes of action 17, 27 are coaxial with one another, are also envisaged.

Of course, other embodiments and arrangements with a different number and/or size of hydraulic braking parts 15 and/or electromechanical braking parts 25 are also possible, e.g. with two hydraulic braking parts 15 and one electromechanical braking part 25. In this case, the axis of action of a hydraulic braking part 15 and of the electromechanical braking part 25 can be arranged coaxially. However, collinear or, alternatively, coaxial arrangement of the respective axes of action is not obligatory.

In the exemplary embodiments which are shown in FIGS. 1 and 2, the hydraulic braking device 10 is arranged on the outward-facing side of the wheel brake 30, that facing away from the motor vehicle, this corresponding to conventional concepts and thus entailing a low outlay on adaptation.

If the electromechanical braking device is used for the function of readjustment for wear and/or setting of the release clearance, as in the present case, the hydraulic braking part 15 can be of very compact design, especially in respect of the axial adjustment travel, since the stroke can be very limited. In this way, the hydraulic braking part 15 can be of very slim design and can come very close to the rim, thus enabling the arrangement to be of very space-saving design.

Accordingly, in the embodiments which are shown, the electromechanical braking device 20 is arranged on the opposite side of the wheel brake 10, that facing the vehicle, and this may be advantageous in respect of the arrangement of the drive unit 21.

According to a particularly advantageous embodiment, the hydraulic braking device 20, as shown in the exemplary embodiments in FIGS. 1 and 2, is designed as a closed hydraulic system within the wheel brake 30. This means that the wheel brake 30 includes the components and functions required for the operation of the hydraulic braking device without the need for a supply, of fluid for instance, from a higher-level system.

This makes it possible be compensated by the electromechanical braking device 20. As a result, the to eliminate the need to make provision for a fluid tank since lining wear can hydraulic braking device 10 is of compact and space-saving design, as depicted. Accordingly, the hydraulic system 10 can also be of low-maintenance or even maintenance-free design if the hydraulic system is configured for the expected life of the wheel brake.

The hydraulic braking device 10 includes a driving device 11, designed in the exemplary embodiment as a motor gear unit, which is arranged on or alternatively, as shown, within the wheel brake 30 and is operatively connected to the hydraulic line 12 in order to move the hydraulic braking part 15 in translation during operation. To build up pressure, a transmitter element 13 is provided, which is designed as a hydraulic pump and is connected to the hydraulic line 12. Here, the transmitter element 13 is likewise arranged on or within the wheel brake 30.

The drive unit 21 of the electromechanical braking device 20 is designed to generate a torque and is likewise arranged on or within the wheel brake 30, as can be seen in FIG. 1 or 2. The transmission unit 22 can transmit the torque of the drive unit 21 to the electromechanical braking part 25, wherein a rotation-translation mechanism 23 is furthermore provided. In the present case, the rotation-translation mechanism 23 is designed as a spindle drive with a spindle 24.

In the case where there is more than one electromechanical braking part 25, the torque of the electromechanical braking device 20 can be transmitted to the other electromechanical braking parts 25 by means of another transmission stage 28. In the embodiment of the invention which is shown by way of example in FIG. 1, a spur gear transmission is provided for this purpose. In the embodiment shown by way of example in FIG. 2, the transmission unit 22 transmits the torque to a worm gear mechanism 29.

An electronic control unit (“ECU”) is provided for the control of the hydraulic braking device 10 and accordingly performs pressure control. The electromechanical braking device 20 is also controlled by means of an electronic control unit.

These two control units are combined and therefore only one brake control unit is required, which is arranged as a wheel control unit (“WCU”) on or in the wheel brake 30 according to the embodiments shown by way of example.

However, it is also possible to combine the control of two wheel brakes 30 on one axle, for example, and to provide a common axle control unit or axle controller, which is then connected to the wheel brakes 30 with corresponding signal lines and controls the respective wheel brake 30 in this way. Of course, it is also possible to control all the wheel brakes 30 of the vehicle by way of a central control unit or a central on-board computer by means of corresponding signal lines. The control unit can also be connected in terms of signal transmission to electronic brake pedals, for example.

The wheel brake 30 may include one or, alternatively, more than one, preferably two, three, four or more hydraulic braking devices and/or one or more than one, preferably two or more electromechanical braking devices. The selection and arrangement can depend on the brake application force to be applied or the desired redundancy.

In the case of more than one hydraulic braking device 10 and/or more than one electromechanical braking device 20, these may be arranged parallel to one another, which saves space and also allows a compact construction of the wheel brake 30. An opposed arrangement in pairs, as shown in FIGS. 1 and 2, has proven particularly advantageous.

While the fluid line 12 can easily be routed to a plurality of hydraulic braking parts 15 by means of branching, the distribution of force and torque for the electromechanical braking parts 25 can be accomplished by means of transmission stages, as shown in FIGS. 1 and 2.

The invention also relates to a motor vehicle (not illustrated) having at least one wheel brake 30 as described above.

### LIST OF REFERENCE SIGNS

10 Hydraulic braking device
11 Driving device
12 Hydraulic line
13 Transmitter element
14 Pressure sensor
15 Hydraulic braking part
16 Friction lining
17 Hydraulic axis of action
20 Electromechanical braking device
21 Drive unit
22 Transmission unit
23 Rotation-translation mechanism
24 Spindle
25 Electromechanical braking part
26 Friction lining
27 Electromechanical axis of action
28 Transmission stage
29 Worm gear mechanism
30 Brake caliper module
31 Brake caliper housing
32 Axis of action

1. A wheel brake for a motor vehicle, comprising:
a brake caliper module having a brake caliper housing;
at least one hydraulic braking device having a hydraulic braking part;
at least one electromechanical braking device having an electromechanical braking part;
a friction partner arranged between the hydraulic braking part and the electromechanical braking part; wherein
the hydraulic braking device is configured to move the hydraulic braking part axially, thereby enabling a first axial force F_{H} to be applied during operation;
the electromechanical braking device is configured to move the electromechanical braking part axially, thereby enabling a second axial force F_{E} to be applied during operation; and wherein
the first axial force F_{H} and the second axial force F_{E} are directed toward one another.

2. The wheel brake as claimed in claim 1, wherein the hydraulic braking device performs the function of the service brake.

3. The wheel brake as claimed in claim 1, wherein a force measurement is performed by a pressure sensor.

4. The wheel brake as claimed in claim 1, wherein the electromechanical braking device performs at least one of the following functions: readjustment for wear, setting of the release clearance, a parking brake function, redundant emergency actuation, and/or increasing braking dynamics.

5. The wheel brake as claimed in claim 1, wherein the at least one hydraulic braking part defines a first hydraulic axis of action, which corresponds to the axis of symmetry of the hydraulic braking part, and the at least one electromechanical braking part defines a second electromechanical axis of action, which corresponds to the axis of symmetry of the electromechanical braking part, and wherein at least one hydraulic axis of action and at least one electromechanical axis of symmetry are coaxial with respect to one another.

6. The wheel brake as claimed in claim 1, wherein the hydraulic braking part is arranged on an outward-facing side of the wheel brake.

7. The wheel brake as claimed in claim 1, wherein the electromechanical braking part is arranged on a vehicle-facing side of the wheel brake.

8. The wheel brake as claimed in claim 1, wherein the hydraulic braking device is configured as a closed hydraulic system within the wheel brake.

9. The wheel brake as claimed in claim 1, wherein the hydraulic braking device includes a transmitter element for building up pressure and arranged on or within the wheel brake.

10. The wheel brake as claimed in claim 9, wherein the hydraulic braking device includes a driving device arranged on or within the wheel brake and operatively connected to the transmitter element in order to move the hydraulic braking part in translation.

11. The wheel brake as claimed in claim 1, wherein the electromechanical braking device comprises a drive unit for generating a torque and arranged on or within the wheel brake.

12. The wheel brake as claimed in claim 1, wherein the electromechanical braking device comprises a transmission unit and/or a rotation-translation mechanism, wherein the electromechanical braking part may be moved in translation, and wherein the transmission unit and/or the rotation-translation mechanism are/is arranged on or within the wheel brake.

13. The wheel brake as claimed in claim 1, further comprising an electronic control unit (“ECU”) to control the hydraulic braking device and/or the electromechanical braking device, the ECU being disposed on or in the wheel brake.

14. The wheel brake as claimed in claim 1, wherein the brake caliper module is designed as a floating caliper brake.

15. The wheel brake as claimed in claim 1, further comprising more than one hydraulic braking devices and/or more than one electromechanical braking devices.

16. A motor vehicle comprising:
at least one wheel brake, the wheel brake including
a brake caliper module having a brake caliper housing,
at least one hydraulic braking device having a hydraulic braking part,
at least one electromechanical braking device having an electromechanical braking part,
a friction partner arranged between the hydraulic braking part and the electromechanical braking part, wherein
the hydraulic braking device is configured to move the hydraulic braking part axially, thereby enabling a first axial force F_{H} to be applied during operation,
the electromechanical braking device is configured to move the electromechanical braking part axially, thereby enabling a second axial force F_{E} to be applied during operation, and wherein
the first axial force F_{H} and the second axial force F_{E} are directed toward one another.
